(19) United States
(12) Patent Application Publication
(10) Pub. No.: US 2011/0304478 A1
(43) Pub. Date: Dec. 15, 2011

(54) Bicycle alert safety system (BASS)

(76) Inventor: Brian D. Lee, North Miami, FL (US)

(21) Appl. No.: 12/802,878

(22) Filed: Jun. 15, 2010

(51) Int. Cl. G08G 1/01

(52) U.S. Cl. 340/933

(57) ABSTRACT

The wireless networks of the LED's that function in the Wireless Personal Area Network (WPAN) are used for turn indications, braking and illumination of the bicycle and the rider while in traffic. The WPAN incorporated onto the bike and the bicycle accessories is a new feature that provides a new application for wireless technology. This new application called Bicycle Alert Safety System (BASS) will reduce the risk bicyclists encounter while riding in traffic. And BASS will reduce the probability of potentially dangerous accidents between bicyclist and motor vehicles which are at times associated with catastrophic fatalities.

### CROSS REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

I recently made the switch from driving an automobile to riding my bicycle my primary mode of transportation. And in doing so I discovered how unsafe the roads are for a bicyclist. In particular when automobiles are exiting parking lots or making turns at an intersection. Even if the cyclist is riding with traffic on the sidewalk or in the street near the curb, the driver may impede the path of the bicyclist due to the fact that the driver is unaware of the presence of a bicyclist.

I had the misfortune of encountering that exact same scenario when I was struck by an automobile that was exiting a parking lot. The driver stated they never saw me until I was directly in front of their automobile. It was my assumption based upon the driver's actions that they had seen me approaching their vehicle and yielded the right of way. Once my bicycle was in front of the vehicle and the driver pressed the accelerator, there was nothing I could do to prevent the accident from transpiring. I was very fortunate in that I suffered minor injuries from the accident. I know though that other bicyclists and motorcyclists in similar accidents have not been as fortunate. One guy I spoke with that was in a similar accident suffered a broken femur when he was struck by with an automobile. And there is a bike that sits within a mile of my residence in memory of another bicyclist where the fatal accident took place.

The officer who responded to the scene of my accident informed me that technically a bicycle is considered to be a motor vehicle. And he also stated that bicycles should not be ridden on the sidewalk. Therefore I was at fault for the accident for riding my bike on the sidewalk even though it appeared the driver had yielded the right of way. Bicyclists and motorcyclist are very much at the mercy of unattentive drivers.

### BRIEF SUMMARY OF THE INVENTION

The Bicycle Alert Safety System (BASS) is designed to reduce the probability of an accident taking place between a bicycle and an automobile. BASS main feature can alert the driver that a bicyclist is approaching even when the driver cannot see the bicyclist. So whether the driver is leaving a parking lot or their driveway, they can be alerted that there is an approaching bicyclist nearby. BASS also has several features that will distinguish the bicycle from the backdrop of oncoming traffic so that a driver will have a higher probability of seeing a bicyclist approaching their automobile.

### BRIEF DESCRIPTION OF SEVERAL VIEWS OF THE DRAWING

FIG. 1 depicts a backpack with LED's placed along the straps. The LED's are placed on the bag to make the rider visible to drivers.

FIG. 2 depicts the back view of the backpack. Again LED's are placed on the backpack to distinguish the presence of a bicyclist in traffic.

FIG. 3 depicts LED's that are placed on each side of the bike frame. When the LED's are illuminated, they will provide a distinguishing presence for the bicyclist to passing automobiles.

FIG. 4 depicts the top view of a bicycle helmet with LED's illuminated to help establish the presence of the bicyclist in traffic. This is very important feature for bicyclists that are riding at dusk or nighttime.

FIG. 5 depicts the side view of a bicycle helmet with LED's illuminated to help establish the presence of the bicyclist in traffic. This is very important feature for bicyclists that are riding at dusk or nighttime.

FIG. 6a depicts the front view of bicycle pants with LED's illuminated to help establish the presence of the bicyclist in traffic. This is very important feature for bicyclists that are riding at dusk or nighttime.

FIG. 7 depicts the side view of bicycle pants with LED's illuminated to help establish the presence of the bicyclist in traffic. This is very important feature for bicyclists that are riding at dusk or nighttime.

FIGS. 8a and 8b depicts the front and rear view of a bicycle shirt with LED's illuminated to help establish the presence of the bicyclist in traffic. This is very important feature for bicyclists that are riding at dusk or nighttime.

FIGS. 9 and 10 depicts the front and rear view of a safety vest with LED's illuminated to help establish the presence of the bicyclist in traffic. This is very important feature for bicyclists that are riding at dusk or nighttime.

FIG. 11 depicts a transmitter and FIG. 12 depicts the receiver unit that when used together by the bicyclist and driver respectively will reduce the probability of accidents occurring between and bicycle and an automobile.

FIG. 13 and FIG. 14 depicts the voice activated turn signal indicators affixed to the front handlebars and rear seat post of the bicycle respectively.

FIG. 15 depicts the front handlebars with the voice activated brake located on the left side of the handlebar. And the voice activated turn indicator button is on the right side of the handlebar. Also shown in the figure is a depiction of the transmitter affixed to the handlebar.

FIG. 16 depicts a dashboard with the LED illuminated and the audio file playing when approaching a bicyclist that is broadcast a wireless signal.

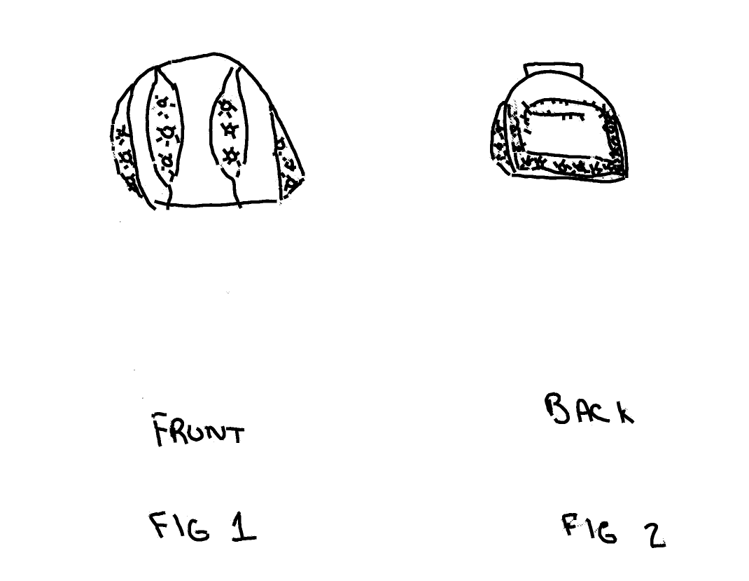

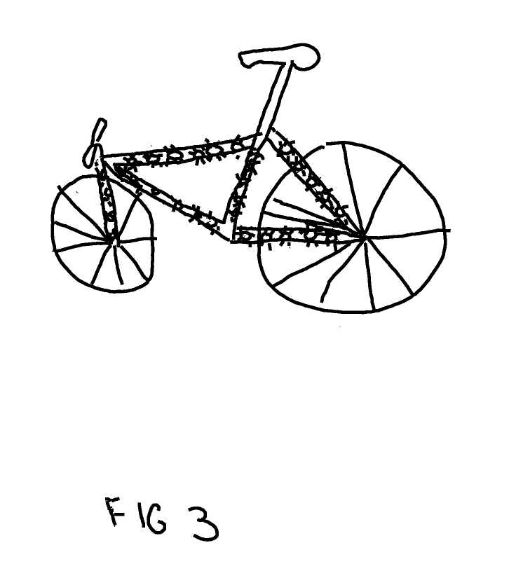

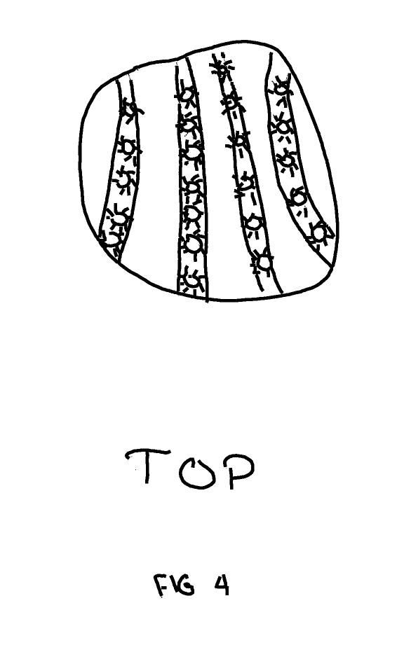

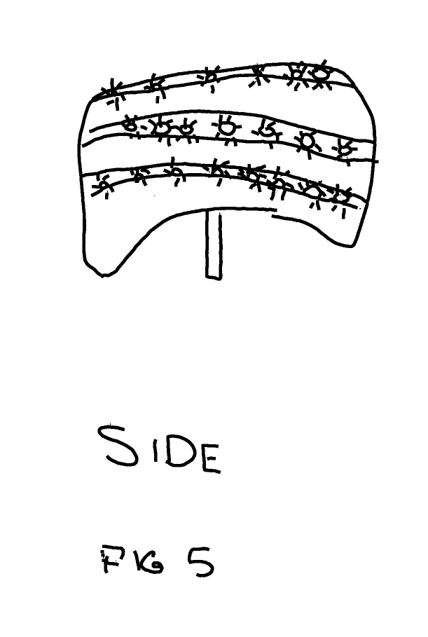

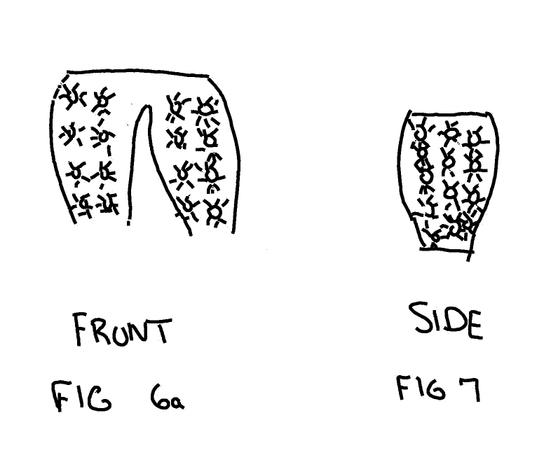

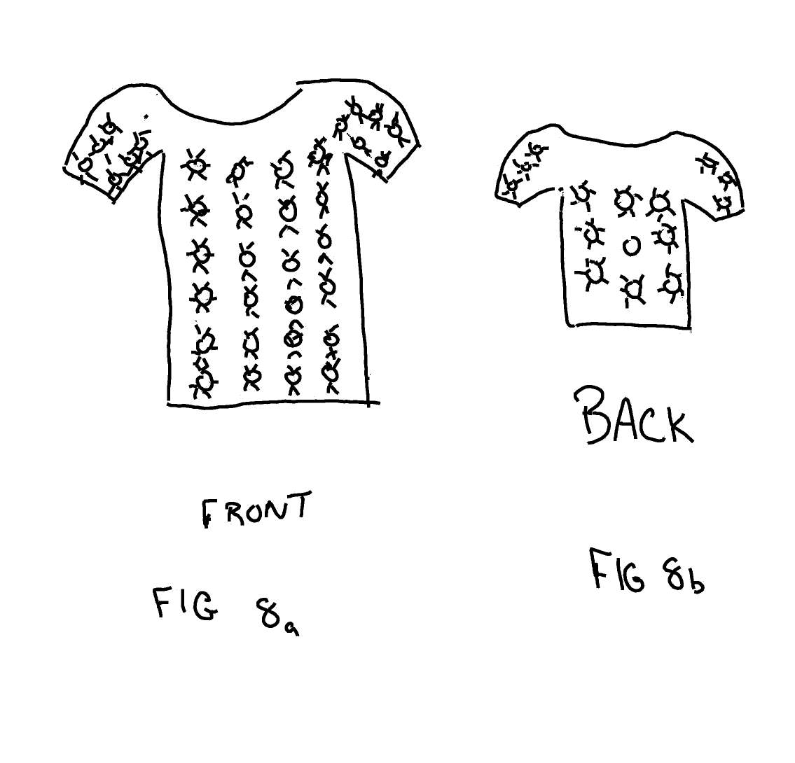

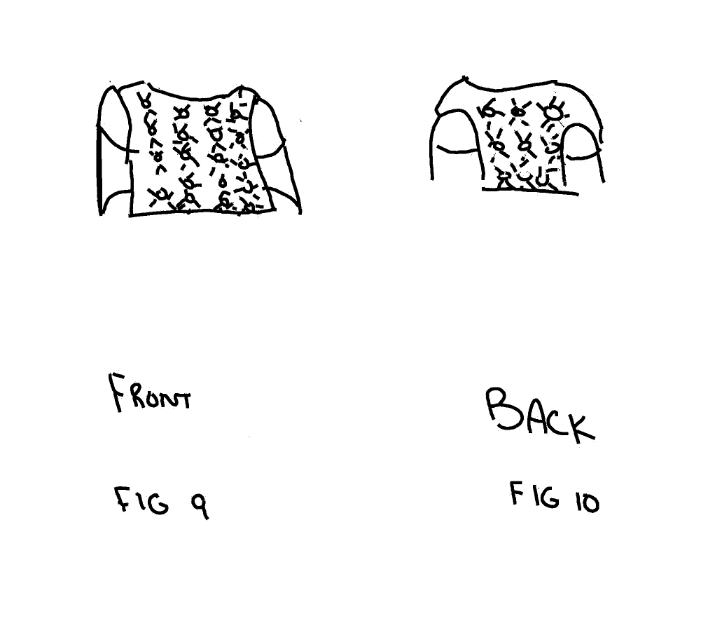

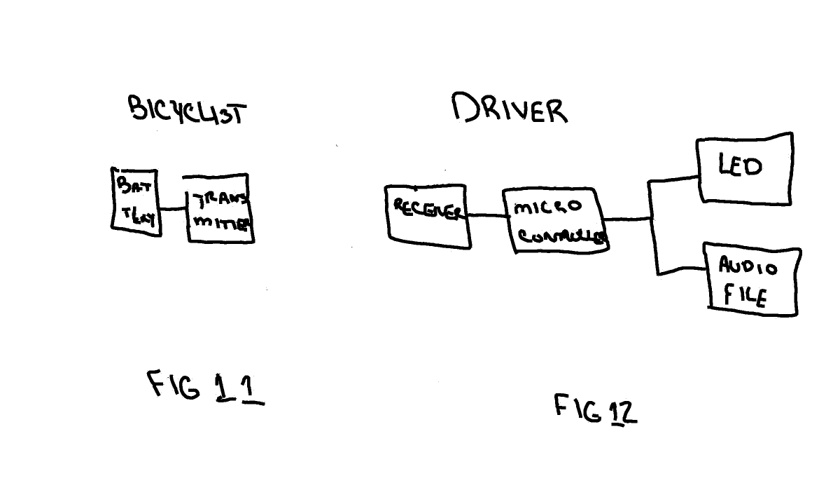

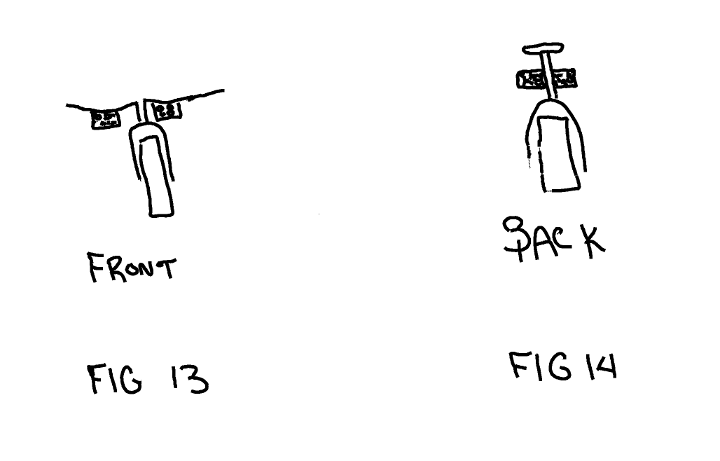

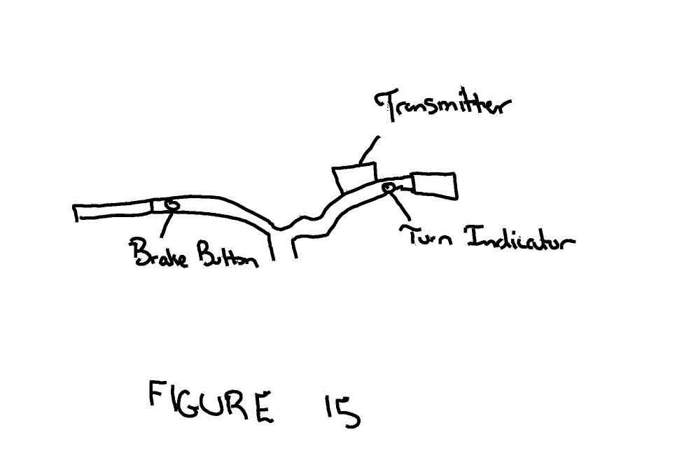

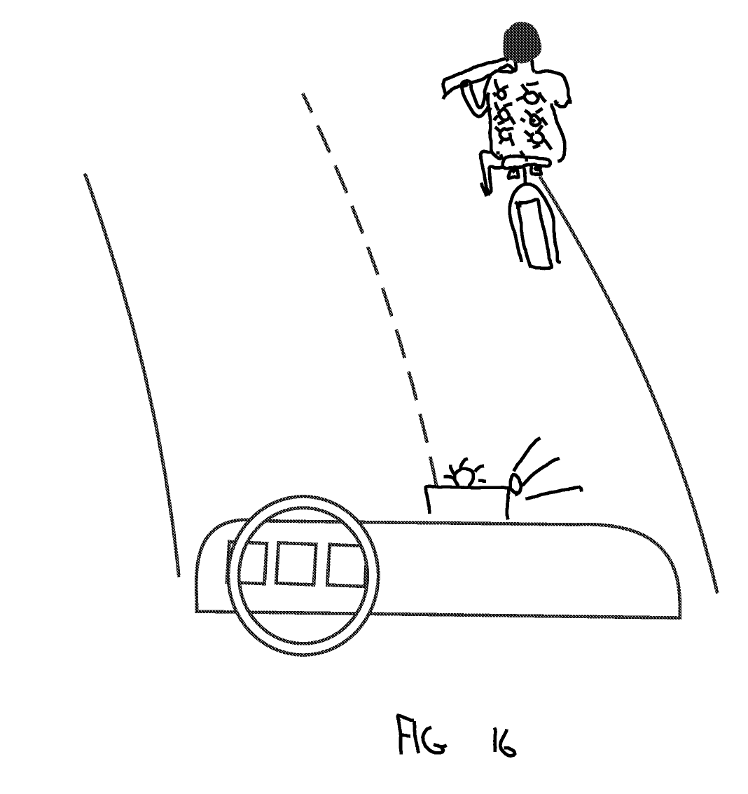

### DETAILED DESCRIPTION OF THE INVENTION

The backpack is manufactured with LED's casing sewn into the bag. The LED's are powered by a battery source with an on/off switch, a microcontroller (MC) and a receiver inside the backpack. The transmitter is located on the bike. When the bicyclist moves the switch to the desired turn indication, the transmitter sends a wireless signal to the receiver in the backpack. The receiver then sends a signal to the MC which illuminates the appropriate yellow LED's for indicating a turn. When the bicyclist presses the switch indicating the intention of braking or decelerating, the red LED's are illuminated on the backpack. When riding, the bicyclist can choose to have the LED's permanently illuminated or flashing.

The shirt is manufactured with LED's casing sewn onto the shirt. The LED's are powered by a battery source with an on/off switch, a microcontroller (MC) and a receiver on the shirt. The transmitter is located on the bike. When the bicyclist moves the switch to the desired turn indication, the transmitter sends a wireless signal to the receiver on the shirt. The receiver then sends a signal to the MC which illuminates the appropriate yellow LED's for indicating a turn. When the bicyclist presses the switch indicating the intention of braking or decelerating, the red LED's are illuminated on the shirt. When riding, the bicyclist can choose to have the LED's permanently illuminated or flashing.

The pants are manufactured with LED's casing sewn onto the pants. The LED's are powered by a battery source with an on/off switch, a microcontroller (MC) and a receiver on the pants. The transmitter is located on the bike. When the bicyclist moves the switch to the desired turn indication, the transmitter sends a wireless signal to the receiver on the pants. The receiver then sends a signal to the MC which illuminates the appropriate yellow LED's for indicating a turn. When the bicyclist presses the switch indicating the intention of braking or decelerating, the red LED's are illuminated on the pants. When riding, the bicyclist can choose to have the LED's permanently illuminated or flashing.

The helmet is manufactured with LED's casing affixed to the helmet. The LED's are powered by a battery source with an on/off switch, a microcontroller (MC) and a receiver on the helmet. The transmitter is located on the bike. When the bicyclist moves the switch to the desired turn indication, the transmitter sends a wireless signal to the receiver. The receiver then sends a signal to the MC which illuminates the appropriate yellow LED's for indicating a turn. When the bicyclist presses the switch indicating the intention of braking or decelerating, the red LED's are illuminated on the helmet. When riding, the bicyclist can choose to have the LED's permanently illuminated or flashing.

The bicycle frame will have the LED's casing affixed to the frame on all sides. The LED's are powered by a battery source with an on/off switch, a microcontroller (MC) and a receiver on the helmet. The transmitter is located on the bike. When the bicyclist moves the switch to the desired turn indication, the transmitter sends a wireless signal to the receiver. The receiver then sends a signal to the MC which illuminates the appropriate yellow LED's for indicating a turn. When the bicyclist presses the switch indicating the intention of braking or decelerating, the red LED's are illuminated. When riding, the bicyclist can choose to have the LED's permanently illuminated or flashing.

The turn indicators are manufactured with LED's casing affixed to the handle bars and seat post on the bike frame. The LED's are powered by a battery source with an on/off switch, a microcontroller (MC) and a receiver on the bike. The transmitter is located on the bike handlebars. When the bicyclist states a desired turn indication, the transmitter sends a wireless signal to the receiver on the bike frame. The receiver then sends a signal to the MC which illuminates the appropriate yellow LED's for indicating a turn. When the bicyclist states their indication of braking or decelerating, the red LED's are illuminated on the bike frame. When riding, the bicyclist can choose to have the LED's permanently illuminated or flashing.

The Alerting Transmitter is located on the handlebars. The transmitter broadcast a signal to any receiving units that are in the wireless network area. All receiving units located in wireless area network upon receiving this signal will send a signal to the MC located on the dashboard. The MC will illuminate the LED that is on the dashboard. And the MC will play an audio file embedded in the MC that warns the driver of an approaching bicyclist.

1. BASS creates a wireless area network when used in conjunction with a transmitter and receiver that will alert the driver of an approaching bicyclist on the road.
BASS utilizes wireless technology to alert the driver of an approaching bicyclist.
BASS utilizes LED's to illuminate the rider through bicycle accessories, clothing and the bicycle frame.
BASS is manufactured to enhance the safety of the bicyclist by providing lighting to different parts of the rider and the bike in order to distinguish the rider and the bike from traffic.
BASS will help reduce the probability of an accident occurring between the car and the bicycle.
BASS will not prevent an accident from occurring.
The parts used to manufacture BASS are not guaranteed to perform.
BASS is not guaranteed to perform.
Any damages caused by an accident with the driver and bicyclist utilizing BASS are solely the responsibilities of the driver and the bicyclist involved in the accident.
IRP Industries accepts no liability or responsibility in the event of an accident taking place where BASS is utilized.
